(19) United States
(12) Patent Application Publication
(10) Pub. No.: US 2016/0042467 A1
(43) Pub. Date: Feb. 11, 2016

(54) PROFIT GAUGE FOR COMMERCIAL VEHICLES

(71) Applicant: RONALD VERNE DELONG, GILBERT, AZ (US)

(72) Inventor: RONALD VERNE DELONG, GILBERT, AZ (US)

(21) Appl. No.: 14/299,707

(22) Filed: Jun. 9, 2014

Related U.S. Application Data
(60) Provisional application No. 61/834,713, filed on Jun. 13, 2013.

(51) Int. Cl. G06Q 40/00; G07C 5/12; G07C 5/08

(52) U.S. Cl. CPC G06Q 40/12; G07C 5/0808; G07C 5/085; G07C 5/12

(57) ABSTRACT

Profit for commercial vehicles often consists of two major factors, the amount the vehicle is reimbursed for transporting cargo minus the cost of actually transporting the cargo. The reimbursement usually consists of two main components, (1) the reimbursement rate based on distance driven and (2) the fuel surcharge rate, also based on distance driven. The actual cost is made up of both fixed and distance based costs. The over-riding cost is for fuel. The invention uses settings made by the vehicle operator to a computing device which is connected to sensors in the vehicle. The computing device uses the inputs from the operator and measurements from the vehicle to display a continuously updated value of profit (or loss) to the vehicle operator as a real currency amount per unit time. The practical result is that the operator is able to make adjustments such as speed and gearing and use the displayed feedback to optimize the profit or minimize the loss for the current driving conditions.

### FIELD OF THE INVENTION

This invention relates to a method of determining the profit-per-hour a commercial vehicle transporting cargo or persons is producing both in real-time and over longer periods of time and displaying this to the operator. This allows the operator to make adjustments to things such as speed, gearing and other vehicle operating parameters and directly observe the impact of these changes on the profit or loss being obtained.

### BACKGROUND OF THE INVENTION

In the current state of the art, commercial vehicle operators desire to maximize the amount of profit being made for their services and they realize that the way they drive the vehicle has a direct impact on this. In the current art, they have to rely on indirect assumptions and feedback from the vehicle instrumentation to guess at the methods of driving that will optimize the profit.

Currently, the operators negotiate the best reimbursement rate and fuel surcharge rates they can get in order to optimize the revenue stream received for providing the transportation. This rate is usually given as a monetary amount per distance unit. For instance, in the United States, the rate for both are in dollars-per-mile. In order to maximize profit, the operator must reduce the actual cost for providing this service. The largest cost to the operator that the operator has some control over while doing the actual delivery is fuel cost. The combination of these factors provide a base profit point. Total realized profit may require the inclusion of other fixed and variable costs and taxes, but optimizing the base profit also generally optimizes realized profit.

Often, the total hours an operator can drive is limited by law or by practical considerations for the operator. It is, therefore, the goal of the operator to maximize the profit-per-hour. There is a direct conflict between the revenue stream which would require the operator to drive as fast as possible and the fuel cost, which in a modem commercial vehicle, increases significantly on a per-mile basis as the vehicle speed is increased. There is an optimum speed where the revenue stream minus the cost yield the best profit-per-hour. Speed is not the only factor, but is a good example of how revenue stream and cost often work counter to each other, and it is the single largest factor the driver has control over to maximize profit-per-hour.

A method of computing and displaying the combined results of reimbursement rate and fuel cost and displaying to the driver the results of these as a profit-per-hour would allow the driver to adjust speed, gear selection and other factors they control to find the conditions that result in the highest profit-per-hour. Further, a display of overall results by showing profit over a longer period, such as during the contracted delivery period would be useful to the operator to make strategic decisions that could optimize profit-per-hour. These factors could involve such things as contracts to accept and vehicle modifications and maintenance decisions.

### BRIEF SUMMARY OF THE INVENTION

The determination of the base profit can be made by combining the reimbursement rate with the cost of fuel. The reimbursement rate includes revenue such as the basic transportation and fuel reimbursement rate. These combined values can be entered by the operator of the commercial vehicle. They can be adjusted as needed by the operator. The cost of fuel is a function of the actual cost per-unit-volume of the fuel and the fuel consumption rate per-unit-distance of the commercial vehicle. The cost per-unit-volume of fuel is entered by the operator when fuel is added to the vehicle. The fuel consumption rate per-unit-distance, also called fuel-economy, is a value which is subject to many variables and must be computed at regular intervals using a system that senses fuel consumption rate and vehicle speed. In a modern commercial vehicle, this information is usually available from the vehicle computers and a method of extracting this information is generally all that is needed to obtain this information.

The invention will accept the required input from the operator and vehicle computer and make the necessary computations to allow the profit-per-hour to be displayed in real-time to the operator. It can contain some data smoothing as needed to show trends. Further, it can contain data storage and computation capability that would allow the operator to retrieve longer-term summations of the profit-per-hour.

### BRIEF DESCRIPTION OF THE DRAWINGS

FIG. 1 shows a simplified block diagram of the invention.

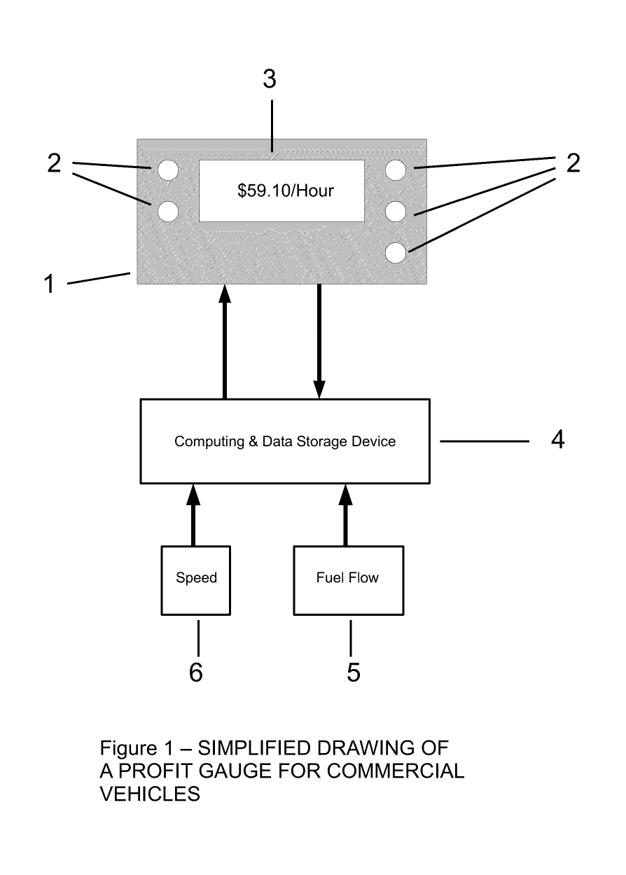

### DETAILED DESCRIPTION OF THE INVENTION

In accordance with the present invention, and in a preferred embodiment, the invention consists of a display/input/output unit 1 with push buttons 2 that allow the operator to enter the reimbursement rate and the fuel cost-per-unit-volume. The display 3 provides feedback to the operator about the computed profit-per-hour. A computing and storage device 4 takes the inputs from the operator and from a fuel flow sensor 5 and speed sensor 6 and computes the profit-per-hour that it passes to the display/input/output unit 1 to be shown on the display 3. The buttons 2 can be used by the operator to retrieve longer-term information to be displayed on the display 3 as desired.

The computation is made by using the following formula:

(Speed×Reimbursement Rate per hour)−(Fuel Flow per hour×Cost of fuel per unit volume)

For instance, using the following values the computed value can be obtained:

Speed=60 mile-per-hour

Reimbursement Rate per-mile=$1.60

Fuel Flow=9 gallons-per-hour

Cost of fuel=$4.10 per-gallon

Applying the formula:

(60×$1.60)−(9×$4.10)=$59.10 per-hour

It is important to note that although the Speed and Fuel Flow are shown as separate inputs to the computing device, in practice they may be combined in other computing devices and passed via a single messaging connection known as a bus. For instance, in a modern commercial vehicle, the engine computer and transmission computer are connected to these sensors and use a bus connection to provide this information to each other and to other computing devices that may need this information. Most commercial vehicles use either the Society of Automotive Engineers J1708 or J1939 standard which describe the electrical and mechanical characteristics of a bus. The computing device in this case can connect to this information bus and retrieve the speed and fuel flow data directly. This connection may be made by connecting to the diagnostic connector that is commonly found in commercial vehicles and is commonly used for troubleshooting purposes.

Further, the Computing and Data Storage Device 4 may be combined into the display/input/output unit 1 and use a single wire cable and a diagnostic connector compatible plug to connect to the existing communications bus in the vehicle. This shows how a single unit may be easily connected to a commercial vehicle and provide the function of the invention. Of course, the invention is not limited to this implementation, as it is only an example.

We claim:

1. A method to determine the profit/loss of a commercial vehicle and display it in real-time to the operator of the vehicle, allowing the operator to make adjustments to speed and other variables under his control to maximize this profit or minimize the loss:
a) a device with provisions to allow the operator or agent to enter the reimbursement rate, fuel cost and include other factors related to profit/loss in these entries.
b) a device which can compute distance and fuel use rate by direct connection to the vehicle computing device or vehicle sensors.
c) a device which can use the vehicle data and the driver inputs to compute the profit/loss-per-unit time and total profit/loss over a specific period of time or route.
d) a device with a display that can be observed by the operator displaying the computed values.

2. The device of claim 1 with the ability to average or smooth the data being displayed to minimize rapid changes of the displayed value caused by random or operator induced short-term changes. This better allows the operator to see the longer-term impact of their changes.

3. The device of claim 1 with the ability to store the information for later retrieval by the operator. This allows for better strategic decisions on contract requirements and vehicle modifications that will positively impact profit.
